(19) United States
(12) Patent Application Publication
(10) Pub. No.: US 2015/0100919 A1
(43) Pub. Date: Apr. 9, 2015

(54) DISPLAY CONTROL APPARATUS AND CONTROL METHOD OF DISPLAY CONTROL APPARATUS

(71) Applicant: CANON KABUSHIKI KAISHA, Tokyo (JP)

(72) Inventor: Yousuke Takagi, Yokohama-shi (JP)

(21) Appl. No.: 14/506,519

(22) Filed: Oct. 3, 2014

(30) Foreign Application Priority Data
Oct. 8, 2013 (JP) 2013-211303

(51) Int. Cl. G06F 3/0484; G06F 3/0488; G06F 3/0481

(52) U.S. Cl. CPC G06F 3/04845; G06F 3/0481; G06F 3/04842; G06F 3/0488
USPC 715/798

(57) ABSTRACT

There is provided a display control apparatus in which an image is smoothly switched to another image by a touch operation while maintaining an enlargement position. A control unit of the display control apparatus controls, when a first image is enlarged and displayed on a display unit, switching from enlargement display of the first image to enlargement display of a second image on the display unit, based on a position instructed with respect to the first image, in response to touch positions of at least two points being touched moving in a same direction in a state where a touch detection unit has detected that the at least two points are being touched.

### BACKGROUND OF THE INVENTION

1. Field of the Invention

The present disclosure generally relates to a display control apparatus and a control method of the display control apparatus. In particular, the present invention relates to a technique for displaying a still image recorded in a storage medium and performing enlargement display of the still image.

2. Description of the Related Art

In recent years, a continuous shooting function has improved in a digital camera, and scenes in which the continuous shooting function is used are increasing. As a result, there is a demand for means for easily selecting the image which is best focused among a plurality of images that has been captured with respect to the same object.

In general, when a user confirms the focus, the user enlarges and displays a portion of the captured image in a focused state and then confirms the focus state by sight. In such a case, the user rotates a cross key or a wheel, i.e., a rotational operation member, in a conventional digital camera. As a result, the image can be switched to another image which has been continuously captured while maintaining an enlargement position and magnification, and the user can confirm the focus of the plurality of images. Such a technique is discussed in Japanese Patent Application Laid-Open No. 2006-060387.

Further, a touch panel has been increasingly used in devices capable of displaying images. Japanese Patent Application Laid-Open No. 8-76926 discusses a technique in which a user can instruct page advancing by a touch operation on the touch panel. The page is displayed according to the number of fingers that have been touched. More specifically, a subsequent page is displayed by an operator touching by one finger, a second subsequent page by touching by two fingers, and a third subsequent page by touching by three fingers.

In recent digital cameras including the touch panel, the magnification can be changed and the enlargement position can be moved by the touch operation. However, there is no means for switching to other image while maintaining the enlargement position, so that the user cannot efficiently confirm the focus.

### SUMMARY OF THE INVENTION

The present disclosure is directed to a display control apparatus capable of smoothly switching to another image while maintaining the enlargement position by performing the touch operation, and the control method of the display control apparatus.

According to an aspect of the present disclosure, a display control apparatus includes a touch detection unit configured to detect a touch operation on a display unit, an enlargement display unit configured to enlarge and display a range of a portion of an image displayed on a display area of the display unit, an enlargement position instruction unit configured to instruct, in a case where an image is enlarged and displayed on the display unit, changing an enlargement position of the image, which has been enlarged and displayed, based on movement of a touch position of one point in a state where the touch detection unit has detected that the one point has been touched, and a control unit configured to control, in a case where a first image is enlarged and displayed on the display unit, switching a display on the display unit from enlargement display of the first image to enlargement display of a second image based on a position instructed by the enlargement position instruction unit with respect to the first image, according to touch positions of at least two points moving in a same direction in a state where the touch detection unit has detected that the at least two points are being touched.

Further features of the present disclosure will become apparent from the following description of exemplary embodiments with reference to the attached drawings.

### BRIEF DESCRIPTION OF THE DRAWINGS

FIG. 1 is an external view of a digital camera according to an exemplary embodiment of the present disclosure.

FIG. 2 is a block diagram illustrating a configuration example of the digital camera according to an exemplary embodiment.

FIG. 3 illustrates a display example in which the image is full-screen displayed on a display unit when performing single reproduction.

FIG. 4 illustrates a display example on the display unit when the image is enlarged and displayed.

FIGS. 5A and 5B illustrate screens indicating an enlarged image advancing operation method.

FIG. 6 is a flowchart illustrating a single reproduction processing according to an exemplary embodiment.

FIG. 7 (7A and 7B) is a flowchart illustrating an enlargement reproduction processing according to an exemplary embodiment.

FIG. 8 (8A and 8B) is a flowchart illustrating the enlargement reproduction processing according to an exemplary embodiment.

FIG. 9 is a flowchart illustrating an enlarged image advancing processing according to an exemplary embodiment.

### DESCRIPTION OF THE EMBODIMENTS

Various exemplary embodiments, features, and aspects of the disclosure will be described in detail below with reference to the drawings.

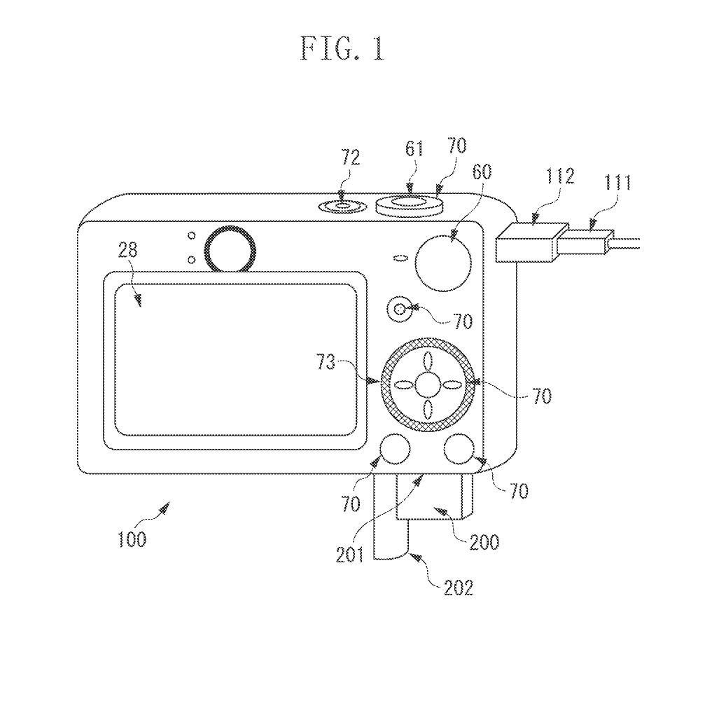

FIG. 1 is an external view illustrating a digital camera as an example of an imaging apparatus according to an exemplary embodiment of the present disclosure.

Referring to FIG. 1, a display unit 28 displays images and various types of information. A shutter button 61 is an operation unit for issuing a shooting instruction. A mode changing switch 60 is the operation unit for switching between various modes.

A connector 112 connects a connection cable 111 and a digital camera 100. An operation unit 70 includes operation members such as various switches, the buttons, and the touch panel which receive various operations from the user. A controller wheel 73 is an operation member included in the operation unit 70 which can be rotatably operated. As used herein, the term “unit” generally refers to any combination of software, firmware, hardware, or other component that is used to effectuate a purpose.

A power switch 72 is a push button for switching between power on and power off. A recording medium 200 is a recording medium such as a memory card and a hard disk. A recording medium slot 201 is a slot for storing the recording medium 200. The recording medium 200 stored in the recording medium slot 201 becomes capable of communicating with the digital camera 100. A cover 202 is a cover of the recording medium slot 201.

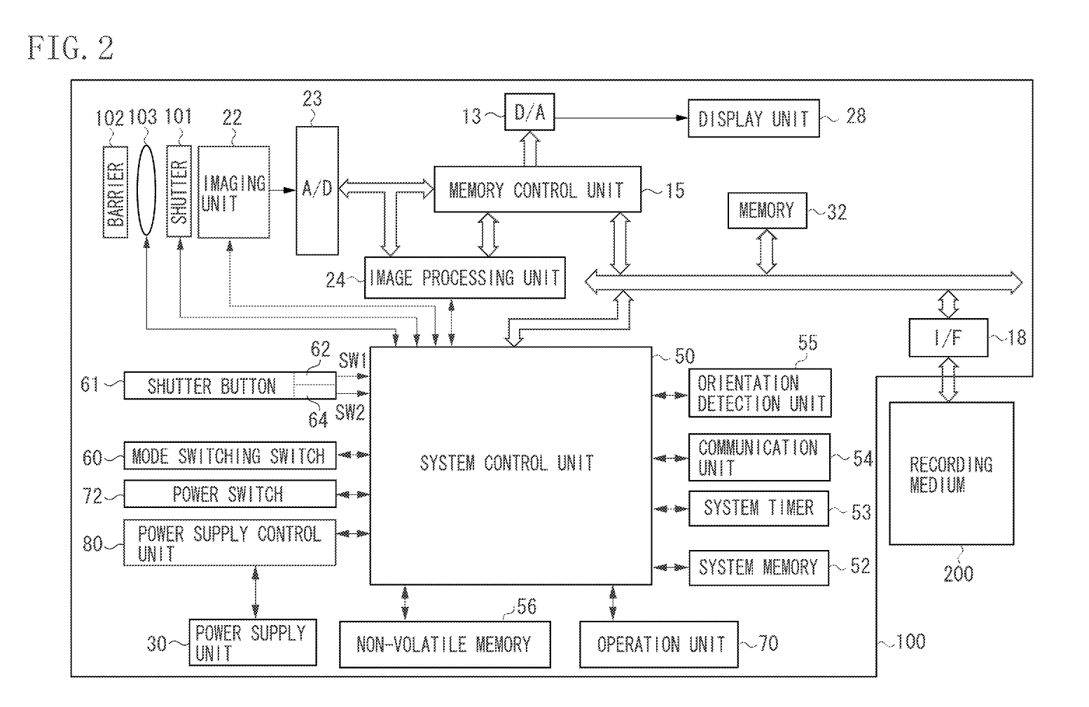

FIG. 2 is a block diagram illustrating a configuration example of the digital camera 100 according to the present exemplary embodiment.

Referring to FIG. 2, an imaging lens 103 is a lens group including a zoom lens and a focus lens. A shutter 101 has a diaphragm function. An imaging unit 22 is an image sensor such as a charge-coupled device (CCD) sensor or a complementary metal oxide semiconductor (CMOS) sensor for converting an optical image to an electric signal.

An analog/digital (A/D) conversion unit 23 is used for converting an analog signal output from the imaging unit 22 into a digital signal. A barrier 102 covers an imaging system including the imaging lens 103 in the digital camera 100 and thus prevents soiling and damaging of the imaging system including the imaging lens 103, the shutter 101, and the imaging unit 22.

An image processing unit 24 performs resizing processing, such as a predetermined pixel interpolation and scaling, and color conversion processing on data received from the A/D conversion unit 23 and a memory control unit 15. Further, the image processing unit 24 performs a predetermined calculation processing using captured image data, and a system control unit 50 performs exposure control and focus control based on the obtained calculation result.

As a result, the image processing unit 24 performs through-the-lens (TTL) auto-focus processing, auto-exposure (AE) processing, and flash pre-emission (EF) processing. Furthermore, the image processing unit 24 performs a predetermined calculation processing using the captured image data and performs TTL auto-white balance (AWB) processing based on the obtained calculation result.

The output data from the A/D conversion unit 23 is directly written in a memory 32 via the image processing unit 24 and the memory control unit 15, or via the memory control unit 15. The memory 32 stores the image data obtained by the imaging unit 22 and converted to the digital data by the A/D conversion unit 23, and the image data to be displayed on the display unit 28. The memory 32 has a memory capacity sufficient for storing a predetermined number of still images, and moving images and sound of a predetermined period of time.

Further, the memory 32 functions as a memory used for performing image display (i.e., a video memory). A D/A conversion unit 13 converts the data for performing image display stored in the memory 32 to the analog signal, and supplies the analog signal to the display unit 28. The image data written in the memory 32 for display is thus displayed by the display unit 28 via the D/A conversion unit 13.

The display unit 28 performs display on a display device such as a liquid crystal display (LCD) according to the analog signal received from the D/A conversion unit 13. The D/A conversion unit 13 performs analog conversion of the digital signal, which has been once A/D-converted by the A/D conversion unit 23 and stored in the memory 32, and sequentially transfers the converted signal to the display unit 28. The display unit 28 then displays the sequentially-transferred data, so that the display unit 28 functions as an electronic view finder capable of performing a through image display (i.e., a live view display).

A non-volatile memory 56 is a memory in which data can be electrically deleted and recorded, such as an electrically erasable programmable read-only memory (EEPROM). The non-volatile memory 56 stores constants and programs to be used for the system control unit 50 to operate. The programs are the programs for executing the various flowcharts to be described below according to the present exemplary embodiment.

The system control unit 50 controls the entire digital camera 100. The system control unit 50 executes the programs recorded in the non-volatile memory 56 to realize the processes according to the present exemplary embodiment to be described below. A system memory 52 is a random access memory (RAM). The constants, variables and the programs read from the non-volatile memory 56 for the system control unit 50 to operate are loaded in the system memory 52. Further, the system control unit 50 performs display control by controlling the memory 32, the D/A conversion unit 13, and the display unit 28. A system timer 53 is a clock unit which measures time required for performing various types of control and time of a built-in clock.

The mode changing switch 60, the shutter button 61, and the operation unit 70 is the operation unit for the user to input the various operation instructions to the system control unit 50. The mode changing switch 60 switches an operation mode of the system control unit 50 to one of a still image recording mode, a moving image recording mode, and a reproduction mode. The still image recording mode includes an auto-shooting mode, an auto-scene determination mode, a manual mode, various scene modes which are shooting settings for each shooting scene, a program AE mode, and a custom mode.

The user can directly switch the mode to one of the modes included in the still image shooting mode by using the mode changing switch 60. Further, the user may once switch the mode to the still image shooting mode using the mode changing switch 60 and then switch the mode to one of the modes included in the still image shooting mode using other operation member. The moving image shooting mode may similarly include a plurality of modes.

When the user half-presses the shutter button 61 (i.e., shooting preparation instruction) provided on the digital camera 100 while operating on the shutter button 61, a first shutter switch 62 becomes on and generates a first shutter switch signal SW1. The generation of the first shutter switch signal SW1 starts the operations such as AF processing, AE processing, AWB processing, and EF processing.

When the user fully-presses the shutter button 61 (i.e., shooting instruction) and completes the operation on the shutter button 61, a second shutter switch 64 becomes on and generates a second shutter switch signal SW2. Upon generation of the second shutter switch signal SW2, the system control unit 50 starts the series of imaging processing, from reading the signal from the imaging unit 22 to writing the image data in the recording medium 200.

Each of the operation members in the operation unit 70 is assigned a function appropriate for each scene selected by the user from various function icons displayed on the display unit 28. The operation members thus operate as the function buttons such as an end button, a return button, an image advancing button, a jump button, a narrow-down button, and an attribute change button. For example, if the user presses a menu button, a menu screen which allows various settings to be specified is displayed on the display unit 28. The user can then intuitively specify various settings using the menu screen displayed on the display unit 28, four direction buttons including up, down, left, and right buttons, and a SET button.

The controller wheel 73 is the operation member included in the operation unit 70 which can be rotatably operated, used along with the direction button for instructing a selection item. If the user rotates the controller wheel 73, an electric pulse signal is generated according to an operation amount, and the system control unit 50 controls each unit in the digital camera 100 based on the pulse signal. An angle and the number of rotations the controller wheel 73 has been rotated can be determined using the pulse signal.

The controller wheel 73 may be any operation member as long as the rotation operation is detectable. For example, the controller wheel 73 may be a dial operation member which generates the pulse signal by rotating according to the rotation operation by the user. Further, the operation member may be a touch sensor (i.e., a touch wheel) which does not rotate and detects the rotation operation by a user's finger on the controller wheel 73.

A power supply control unit 80 includes a battery detection circuit, a direct current to direct current (DC-DC) converter, and a switch circuit for switching a block to be energized. The power supply control unit 80 thus detects whether a battery is attached, a type of the battery, and a battery remaining amount. Further, the power supply control unit 80 controls the DC-DC converter based on the detection result and the instruction from the system control unit 50, and supplies voltage to each unit including the recording medium 200 for associated periods.

A power supply unit 30 includes a primary battery such as an alkali battery or a lithium battery, a secondary battery such as a nickel-cadmium (NiCd) battery, a nickel metal halide (NiMH) battery, or a lithium (Li) battery, and an alternating current (AC) adaptor. A recording medium interface (I/F) 18 is an interface with the recording medium 200 such as the memory card and the hard disk. The recording medium 200, such as the memory card configured of a semiconductor memory or a magnetic disk, records the captured images.

A communication unit 54 connects the camera 100 with external devices wirelessly or using a wired cable, and transmits and receives video signals and audio signals therebetween. The communication unit 54 is also connectable to a local area network (LAN) and the Internet. The communication unit 54 is capable of transmitting the images captured by the imaging unit 22 (including the through images) and the images recorded on the recording medium 200, and capable of receiving the image data and other various types of information from the external devices.

An orientation detection unit 55 detects the orientation of the digital camera 100 with respect to a direction of gravity. Whether the image captured by the imaging unit 22 is an image captured by horizontally or vertically holding the digital camera 100 is determinable based on the orientation detected by the orientation detection unit 55. The system control unit 50 is capable of adding direction information corresponding to the orientation detected by the orientation detection unit 55 to an image file of the image captured by the imaging unit 22, or recording the rotated image. An acceleration sensor or a gyro sensor may be used as the orientation detection unit 55.

The touch panel capable of detecting that the display unit 28 has been touched is included in the operation unit 70. The touch panel and the display unit 28 can be integrated. For example, the touch panel is configured so that transmittance of light does not interfere with the display on the display unit 28, and attached to an upper layer of a display surface of the display unit 28. Input coordinates on the touch panel are then associated with display coordinates on the display unit 28. As a result, a graphical user interface (GUI) which allows the user to operate the screen as if directly operating the screen displayed on the display unit 28 can be configured.

The system control unit 50 is capable of detecting the following operations on the touch panel or the state of the touch panel.

(1) Touching of the touch panel by the finger or a pen (hereinafter referred to as a touch-down)
(2) A state in which the touch panel is being touched by the finger or the pen (hereinafter referred to as a touch-on)
(3) Movement of the finger or the pen while touching the touch panel (hereinafter referred to as a touch-move)
(4) Removal of the finger or the pen which has been touching the touch panel (hereinafter referred to as a touch-up)
(5) A state in which the touch panel is not being touched (hereinafter referred to as a touch-off)

The above-described operations and states (1), (2), (3), (4), and (5) and position coordinates at which the finger or the pen is touching the touch panel are notified to the system control unit 50 via an internal bus. The system control unit 50 then determines the operation which has been performed on the touch panel based on the notified information. In the case of the touch-move operation, a moving direction in which the finger or the pen moves on the touch panel can be determined with respect to each of a vertical component and a horizontal component on the touch panel based on the changes in the position coordinates. As a result, a touch detection function for detecting the touch operation on the display unit 28 can be configured.

Further, if the user performs the touch-up operation after performing a predetermined touch-move operation from the touch-down operation on the touch panel, it is determined that the user has drawn a stroke. An operation of quickly drawing the stroke is referred to as a flick. The flick is an operation in which the user quickly moves the finger for a certain distance while touching the touch panel and then releasing the finger. In other words, the flick is an operation in which the user quickly moves the finger over the touch panel as if flicking the touch panel with the finger.

If it is detected that the user has touch-moved the finger or the pen for a predetermined distance or longer at a predetermined speed or higher and has touched-up, it can be determined that the user has performed the flick operation. Further, if it is detected that the user has touch-moved the finger or the pen for a predetermined distance or longer at a lower speed than the predetermined speed, it can be determined that the user has performed a drag operation. Furthermore, if the user is touching at least two points at the same time and narrows or widens the distance between the two points, the operation is referred to as a pinch operation.

More specifically, the operation in which the distance between the two points is narrowed is referred to as a pinch-in operation. The pinch-in operation is performed by bringing the two fingers close to each other while touching the two points on a multi-touch panel, i.e., moving the fingers over the multi-touch panel as if pinching with the two fingers. On the other hand, the operation in which the distance between the two points is widened while touching the two points at the same time is referred to as a pinch-out operation. Further, a state in which the finger or the pen is brought close to the touch panel without touching the touch panel is referred to as a hover state.

The touch panel may be a resistive film type, an electrostatic capacitance type, a surface acoustic wave type, an infrared type, an electromagnetic induction type, an image recognition type, or an optical sensor type touch panel.

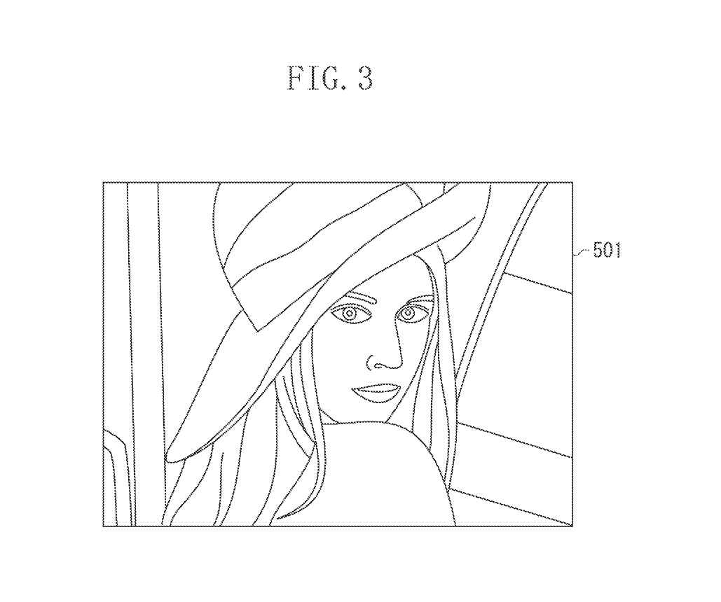

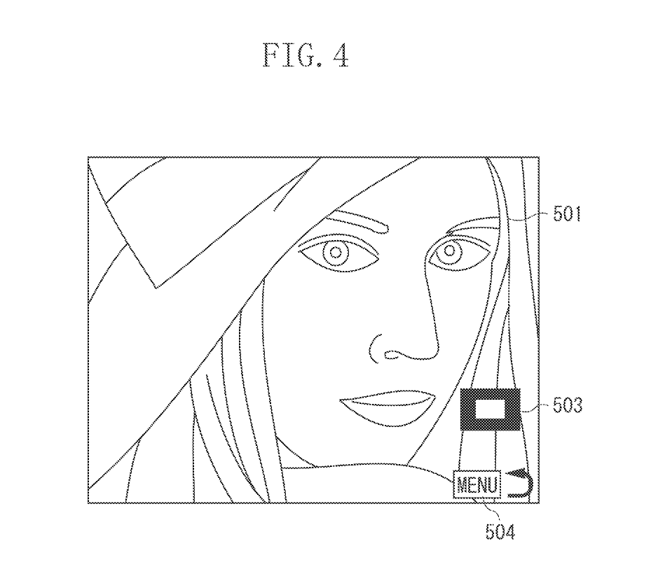

FIG. 3 illustrates a display example in a case where an image 501 (e.g., an image of a file name 0001.jpg) is fully displayed (i.e., the entire image is displayed at a maximum size that can fit in the display area) on the display unit 28. When the image illustrated in FIG. 3 is enlarged, the image is enlarged with respect to the center and becomes as illustrated in FIG. 4.

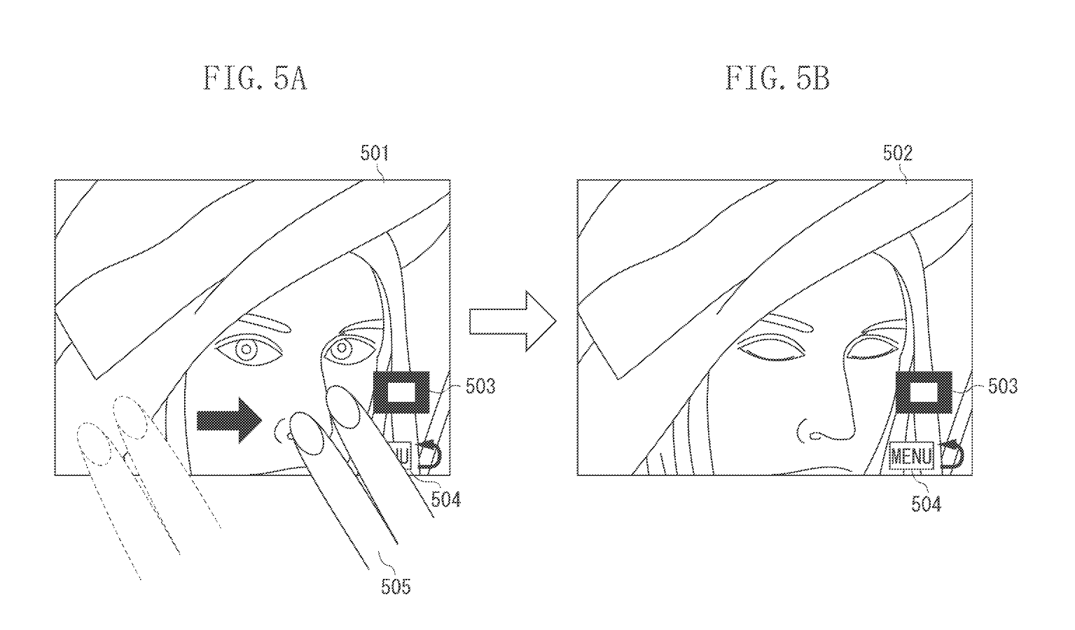

FIG. 4 illustrates a display example on the display unit 28 when the image 501 is enlarged and displayed. Referring to FIG. 4, a portion of the image is enlarged and displayed on the display unit 28 instead of the entire image. A guide 503 indicates an enlarged and displayed portion (i.e., a white-painted portion) among the entire image 501 (i.e., within a black frame). The guide 503 indicates that the center portion of the image 501 is enlarged and displayed in FIG. 4. If the user then issues an enlargement position instruction from such a state and moves the enlargement position to an upper portion, the display state becomes as illustrated in FIG. 5A. Further, a menu button 504 is displayed on the display unit 28.

FIG. 5A is a schematic diagram illustrating a case where the user has touched two points with fingers 505 and has touch-moved the two points when the image 501 is enlarged and displayed with the enlargement position at approximately a center upper portion. According to the present exemplary embodiment, when two points are touch-moved, enlarged image advancing is performed, and the display state changes as illustrated in FIG. 5A to the display state as illustrated in FIG. 5B.

FIG. 5B illustrates a display example in which an image 502 (e.g., an image of the file name 0002.jpg) that is the subsequent image of the image 501 in an image advancing order is enlarged at the same enlargement position as in FIG. 5A. The enlargement position and a percentage of an enlargement range with respect to the entire image are not changed before and after performing the enlarged image advancing operation (from FIG. 5A (i.e., a first image) to FIG. 5B (i.e., a second image)) as indicated by the guide 503. The image advancing in which an enlargement center position and magnification are fixed is thus performed.

The processing for realizing such transition will be described below with reference to the flowcharts.

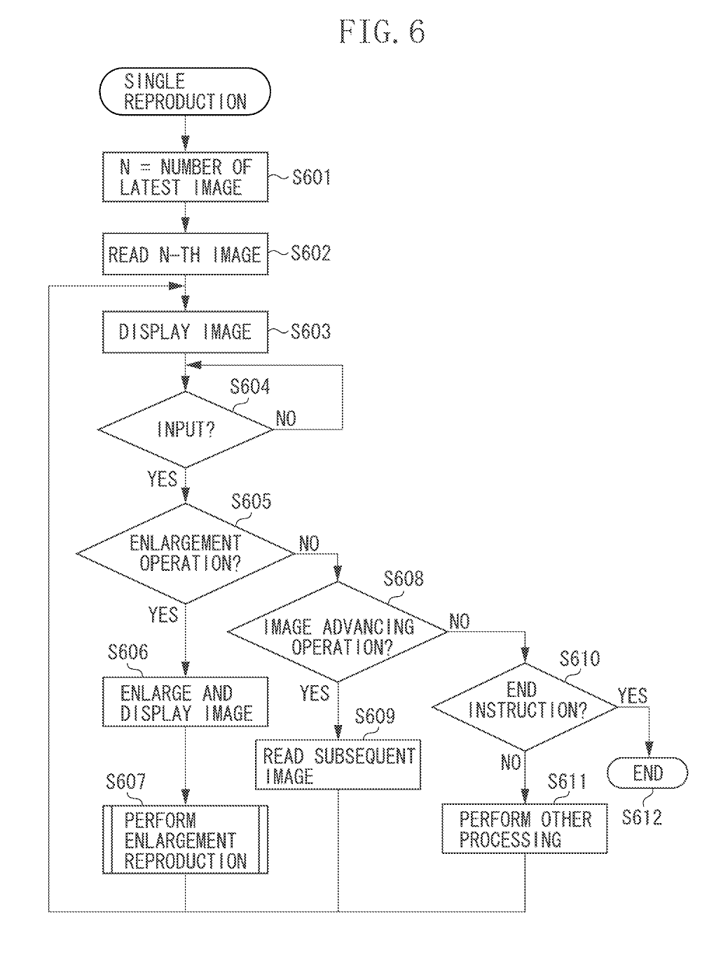

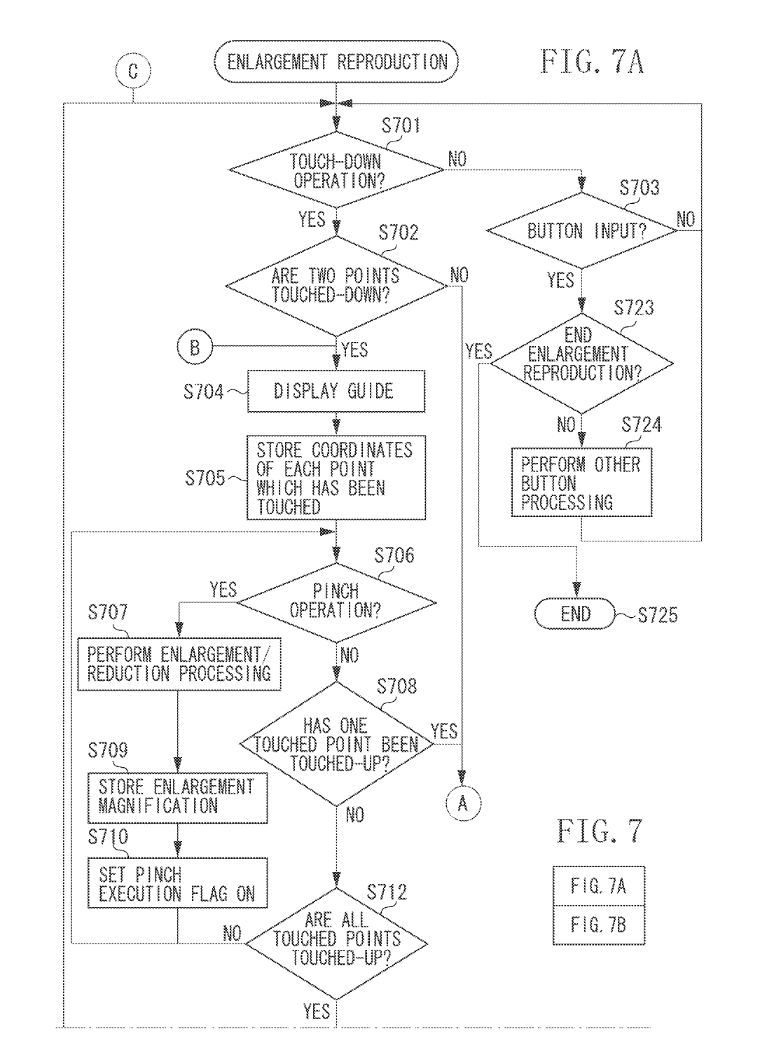

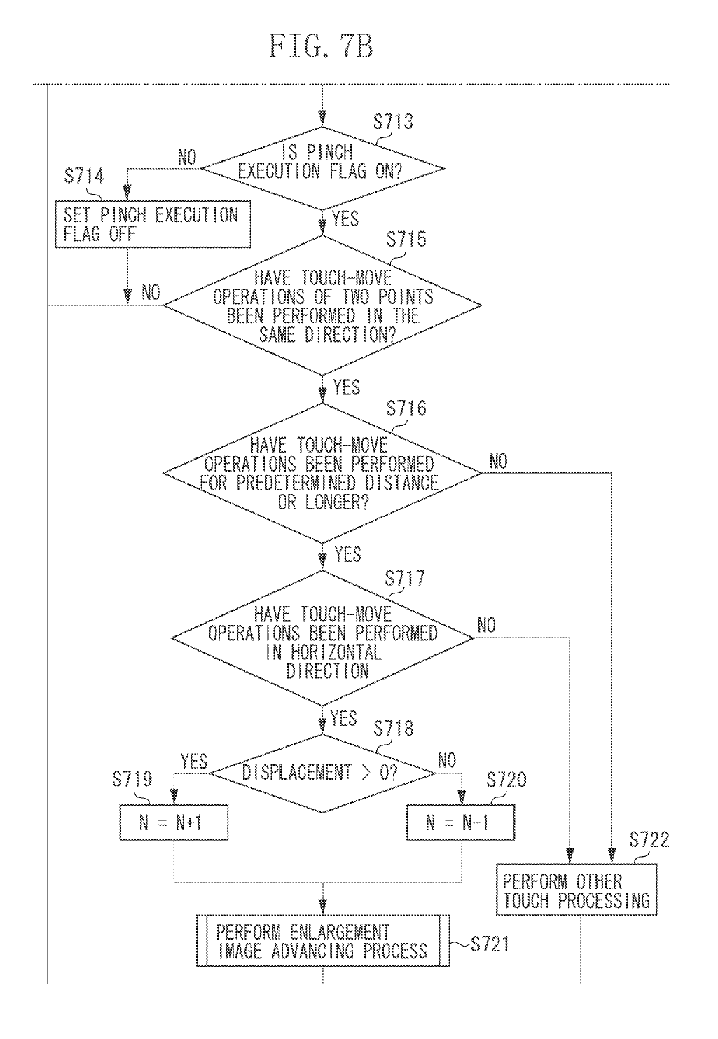

FIGS. 6, 7 (7A and 7B), and 8 (8A and 8B) are flowcharts illustrating operations according to the present exemplary embodiment. The processing is realized by the system control unit 50 loading a program recorded in the non-volatile memory 56 in the system memory 52 and executing the program.

FIG. 6 is a flowchart illustrating a processing procedure of a single reproduction mode for reproducing one image.

In step S601, the system control unit 50 obtains an image number N of the newest image among the images recorded in the recording medium 200.

In step S602, the system control unit 50 reads the Nth image and stores the image in the memory 32.

In step S603, the system control unit 50 decodes the image stored in the memory 32 and displays the decoded image on the display unit 28 as illustrated in FIG. 3.

In step S604, the system control unit 50 determines whether there is an input to the operation unit 70. If there is an input (YES in step S604), the processing proceeds to step S605. If there is no input (NO in step S604), the system control unit 50 stands by until there is input.

In step S605, the system control unit 50 determines whether the input operation is an enlargement operation. For example, the enlargement operation includes operating a zoom lever (i.e., a zoom operation member) included in the operation unit 70 to a tele-side (i.e., an operation similar to enlargement using an optical zoom when capturing an image). Further, the enlargement operation may also be performed by the pinch-out operation on the touch panel. If the input operation is the enlargement operation (YES in step S605), the processing proceeds to step S606. If the input operation is not the enlargement operation (NO in step S605), the processing proceeds to step S608.

In step S606, the system control unit 50 enlarges and displays the image displayed on the display unit 28, and the processing proceeds to step S607 (i.e., refer to FIG. 4). In step S608, the system control unit 50 determines whether the input operation is the image advancing operation. The image advancing operation includes a forward direction operation and a backward direction operation. In a case of the forward direction operation, the image subsequent to the image currently being displayed in an image advancing order is displayed. In a case of the backward direction operation, the image previous to the image currently being displayed in the image advancing order is displayed.

If the user presses a right button among the four direction buttons included in the operation unit 70, performs a clockwise operation on the controller wheel 73, or touch-moves (i.e., drags or flicks) in the right direction by a single touch, the image advancing operation in the forward direction is performed. If the user presses a left button among the four direction buttons included in the operation unit 70, performs a counter-clockwise operation on the controller wheel 73, or touch-moves (i.e., drags or flicks) in the left direction by the single touch, the image advancing operation in the backward direction is performed.

If the input operation is the image advancing operation (YES in step S608), the processing proceeds to step S609. If the input operation is not the image advancing operation (NO in step S608), the processing proceeds to step S610.

In step S609, the system control unit 50 reads the subsequent image in the direction the image advancing has been instructed from the recording medium 200 to the memory 32. The processing then returns to step S603. In step S603, the system control unit 50 displays the read image on the display unit 28.

In step S610, the system control unit 50 determines whether the input operation is an instruction to end the function. If the input operation is an instruction to end the function (YES in step S610), the processing proceeds to step S612, and the processing ends. If the input operation is not an instruction to end the function (NO in step S610), the processing proceeds to step S611. In step S611, the system control unit 50 performs other processing, such as opening the menu screen and displaying indexes.

FIGS. 7 (7A and 7B) and 8 (8A and 8B) are flowcharts illustrating processing performed in an enlargement reproduction mode.

When the user instructs enlargement reproduction in step S607, the enlargement reproduction processing is started. In step S701 illustrated in FIG. 7, the system control unit 50 determines whether the user has performed the touch-down operation. If the touch-down operation has been performed (YES in step S701), the processing proceeds to step S702. If the touch-down operation has not been performed (NO in step S701), the processing proceeds to step S703.

In step S703, the system control unit 50 determines whether there is a button input. If there is a button input (YES in step S703), the processing proceeds to step S723. If there is no button input (NO in step S703), the processing returns to step S701. In step S701, the system control unit 50 stands by for the input.

In step S723, the system control unit 50 determines whether the input operation is for ending the enlargement reproduction. If the input operation is for ending the enlargement reproduction (YES in step S723), the processing proceeds to step S725. In step S725, the enlargement reproduction ends, and the processing returns to step 603. In step S603, the system control unit 50 re-displays the image and stands by for the input.

If the input operation is not for ending the enlargement reproduction (NO in step S723), the processing proceeds to step S724. In step S724, the system control unit 50 performs other button processing, the processing returns to step S701 to stand by for the input. The other button processing includes switching the information to be displayed on the display unit 28.

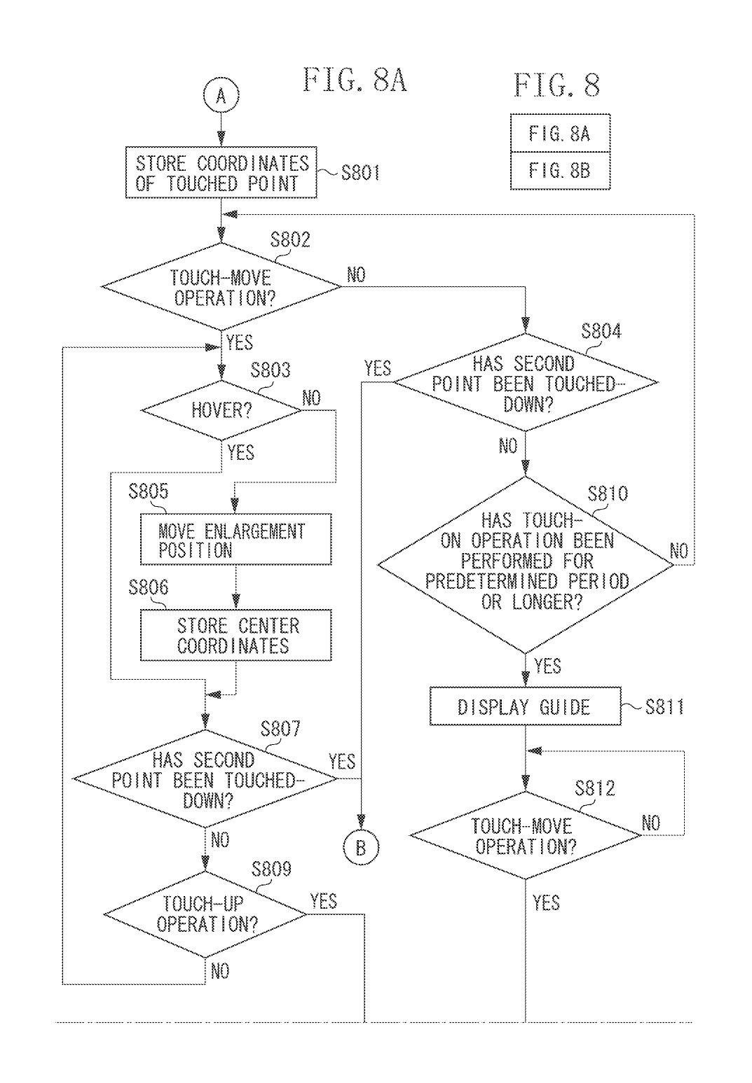

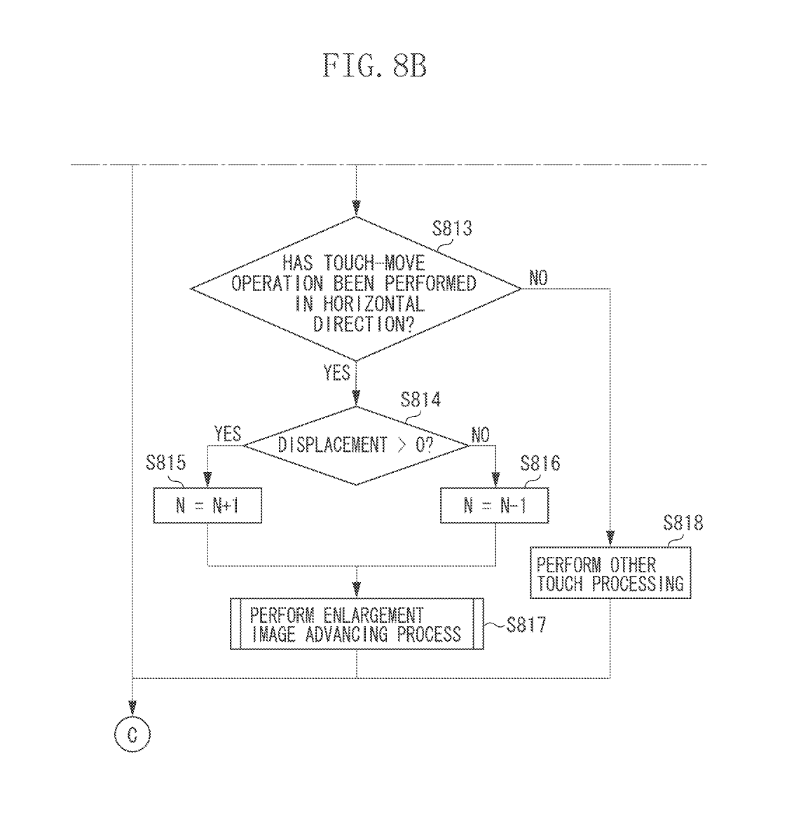

In step S702, the system control unit 50 determines whether the user has touched-down two points. If the user has touched-down two points (YES in step S702), the processing proceeds to step S704. If the user has not touched-down two points (NO in step S702), the processing proceeds to step S801 illustrated in FIG. 8.

In step S704, the system control unit 50 displays a guide indicating the means for performing enlarged image advancing (i.e., the guide indicating that the enlarged image advancing can be performed by touch-moving the two touched points (touch positions) in the same direction (not illustrated)).

In step S705, the system control unit 50 stores the coordinates of each of the touched points in the memory 32, and the processing proceeds to step S706.

In step S706, the system control unit 50 determines whether the user has performed the pinch operation. If the pinch operation has been performed (YES in step S706), the processing proceeds to step S707. In step S707, the system control unit 50 performs enlargement (i.e., a pinch-out) or reduction (i.e., a pinch-in) according to the direction of pinching. The system control unit 50 changes the magnification (i.e., display magnification) according to a magnification instruction and updates the display.

In step S709, the system control unit 50 stores the magnification after performing the enlargement/reduction in the memory 32. In step S710, the system control unit 50 sets on a pinch execution flag (stores in the system memory 52). The pinch execution flag is for storing information on whether the pinch operation has been performed.

If the pinch operation has not been performed (NO in step S706), the processing proceeds to step S708. In step S708, the system control unit 50 determines whether the user has touched-up one point among the two touched points. If one point has been touched-up (YES in step S708), the processing proceeds to step S801. If one point has not been touched-up (NO in step S708), the processing proceeds to step S712. In step S712, the system control unit 50 determines whether all of the touched points have been touched-up.

If all of the touched points have been touched-up (YES in step S712), the processing proceeds to step S713. If no touched points have not been touched-up (NO in step S712), the processing returns to step S706, and the system control unit 50 continues to perform the processing.

In step S713, the system control unit 50 refers to the system memory 52 and determines whether the pinch execution flag has been set “on”. If the pinch execution flag has been set on (YES in step S713), the processing proceeds to step S714. In step S714, the system control unit 50 sets the pinch execution flag “off”, and then causes the processing to return to step S701, and stands by for the input. If the pinch execution flag has not been set “on” (NO in step S713), the processing proceeds to step S715. In step S715, the system control unit 50 determines whether the operation which has been performed before all of the points have been touched up is the touch-move operation of the two touched points in the same direction.

More specifically, the system control unit 50 determines that the two points have been touch-moved in the following case. That is, a difference between the respective coordinates of the two points stored in the system memory 52 when the user has started to touch the two points and the respective coordinates of the two points immediately before it is detected that all points have been touched up in step S712 (i.e., touch-up points) is a predetermined distance or longer. Further, if the directions (i.e., one of up, down, left, and right) of the largest components of the respective differences are the same, the system control unit 50 determines that the two points have been touch-moved in the same direction.

If the two points have been touch-moved in the same direction (YES in step S715), the processing proceeds to step S716. If the two points have not been touch-moved in the same direction (NO in step S715), the processing returns to step S701, and the system control unit 50 stands by for the input.

In step S716, the system control unit 50 determines whether the touch-move operation is of a predetermined distance or longer. If the touch-move operation is of a predetermined distance or longer (YES in step S716), the processing proceeds to step S717. If the touch-move operation is not of a predetermined distance or longer (NO in step S716), the processing proceeds to step S722. In step S722, the system control unit 50 performs other touch processing, and then the processing returns to step S701, and the system control unit 50 stands by for the input. The other touch processing may be deletion of the displayed image or adding a favorite mark.

In step S717, the system control unit 50 determines whether the touch-move operation of the predetermined distance or longer is in a horizontal direction. If the touch-move operation of the predetermined distance or longer is in the horizontal direction (YES in step S717), the processing proceeds to step S718. If the touch-move operation of the predetermined distance or longer is not in the horizontal direction (NO in step S717), the processing proceeds to step S722.

In step S718, the system control unit 50 determines whether a displacement of the touch-move operation of the predetermined distance or longer is the movement in a positive direction (i.e., the right direction). If the displacement is in the positive direction (YES in step S718), the processing proceeds to step S719. In step S719, the system control unit 50 increments the image number N by one. The processing then proceeds to step S721, and the system control unit 50 performs the enlarged image advancing.

As a result, the enlarged image advancing by touching two points as illustrated in FIGS. 5A and 5B is performed.

On the other hand, if the displacement is not in the positive direction (i.e., in a negative direction or the left direction) (NO in step S718), the processing proceeds to step S720. In step S720, the system control unit 50 decrements the image number N by one. The processing then proceeds to step S721, and the system control unit 50 performs the enlarged image advancing.

As described above, the enlarged image advancing is performed after all of the points have been touched up, so that the enlargement position of the image is not changed while the user is performing the touch operation on the two points. The enlargement position is thus prevented from becoming displaced between the previous and subsequent images when the enlarged image advancing is to be performed.

If the user has not touched-down two points (NO in step S702), the processing proceeds to step S801 of the flowchart illustrated in FIG. 8 (8A and 8B) as described above. In step S801, the system control unit 50 stores the coordinates of the one point being touched in the system memory 52. In step S802, the system control unit 50 determines whether the user has then touch-moved the point. If the point has been touch-moved (YES in step S802), the processing proceeds to step S803.

In step S803, the system control unit 50 determines whether a hover is detected other than the point being touch-moved. The hover detection is a proximity detection of whether an operation member such as a pen or a finger has come close to the touch panel at approximately several millimeters from the upper surface thereof (i.e., in a hovering state). If the touch panel is of the electrostatic capacitance type, it is determined that there is a hover when a capacitance greater than a threshold value for detecting hover which is lower than the threshold value for detecting that the touch panel has been touched is detected.

If there is a hover detection (YES in step S803), the processing proceeds to step S807. In step S807, the system control unit 50 determines whether the user has touched-down the other point (i.e., a touch-down of the second point). If the other point has been touched-down (YES in step S807), the processing returns to step S704 illustrated in FIG. 7. In step S704, the system control unit 50 displays the guide for performing enlarged image advancing. According to the present exemplary embodiment, the system control unit 50 determines that the user has touched-down the second point when the touch-down operation is performed within a predetermined period.

If the other point has not been touched-down (NO in step S807), the processing proceeds to step S809. In step S809, the system control unit 50 determines whether the user has performed the touch-up operation. If the touch-up operation has been performed (i.e., a touch-off state in which there is no touched point) (YES in step S809), the processing returns to step S701, and the system control unit 50 stands by for the input. If the touch-up operation has not been performed (NO in step S809), the processing returns to step S803, and the system control unit 50 re-determines whether there is a hover detection.

If there is no hover detection (NO in step S803), the processing proceeds to step S805. In step S805, the system control unit 50 moves the position being enlarged in the image according to the amount of displacement in the touch-move operation. In step S806, the system control unit 50 stores enlargement center coordinates after the enlargement position has been moved in the memory 32, and the processing proceeds to step S807.

As described above, if a hover is detected (i.e., YES in step S803), the enlargement position is not moved (i.e., the processing in step S805 is not performed) even when there is the touch-move operation for the following reason. The hover may be detected due to the user bringing the fingers closer to the touch panel for touching the second point to instruct the enlarged image advancing to be performed.

If the enlargement position changes while the user is to instruct the touch-move operation at two points, the enlargement position becomes displaced between the state previous to performing the touch-move operation at the two points and after performing the enlarged image advancing. However, if the enlargement position is not moved when a hover is detected, i.e., if the enlargement position is moved only when the touch-move operation is to be performed distinctly by a single touch, the enlargement position is prevented from becoming displaced unintentionally while the user is to touch-move at two points.

If the point has not been touch-moved (NO in step S802), the processing proceeds to step S804. In step S804, the system control unit 50 determines whether the other point has been touched-down (i.e., the second point has been touched down). If the other point has been touched-down (YES in step S804), the processing returns to step S704. In step S704, the system control unit 50 displays the enlarged image advancing guide.

If the other point has not been touched-down (NO in step S804), the processing proceeds to step S810. In step S810, the system control unit 50 determines whether a touch-on state is continuing for a predetermined period or longer without the user performing the touch-move operation. In other words, the system control unit 50 determines whether there is a long touch by the single touch.

If the touch-on operation has been performed for a predetermined period or longer (YES in step S810), the processing proceeds to step S811. If the touch-on operation has not been performed for a predetermined period or longer (NO in step S810), the processing returns to step S802.

In step S811, the system control unit 50 displays the guide indicating the operation method for performing enlarged image advancing after the long-touch operation. In such a case, the system control unit 50 displays in the guide that the image can be switched in the enlarged state as follows. That is, the image can be switched by touch-moving in the horizontal direction (in the right or left direction) after continuing the touch-on operation for a predetermined period or longer (i.e., after the long-touch operation).

After displaying the guide, the processing proceeds to step S812. In step S812, the system control unit 50 stands by for the input until the touch-move operation is performed. If the touch-move operation has been performed (YES in step S812), the processing proceeds to step S813.

In step S813, the system control unit 50 determines whether the touch-move operation which has been performed is in the horizontal direction. If the touch-move operation is in the horizontal direction (YES in step S813), the processing proceeds to step S814. If the touch-move operation is not in the horizontal direction (NO in step S813), the processing proceeds to step S818. In step S818, the system control unit 50 performs other touch processing. The processing then returns to step S701, and the system control unit 50 stands by for the input.

In step S814, the system control unit 50 determines whether the movement of the touch-move operation is in the positive direction. If the touch-move operation is in the positive direction (YES in step S814), the processing proceeds to step S815. In step S815, the system control unit 50 increments the image number N by one. If the touch-move operation is not in the positive direction (NO in step S814), the processing proceeds to step S816. In step S816, the system control unit 50 decrements the image number N by one. Then the processing proceeds to step S817. In step S817, the system control unit 50 performs the enlarged image advancing. The processing then returns to step S701, and the system control unit 50 stands by for the input.

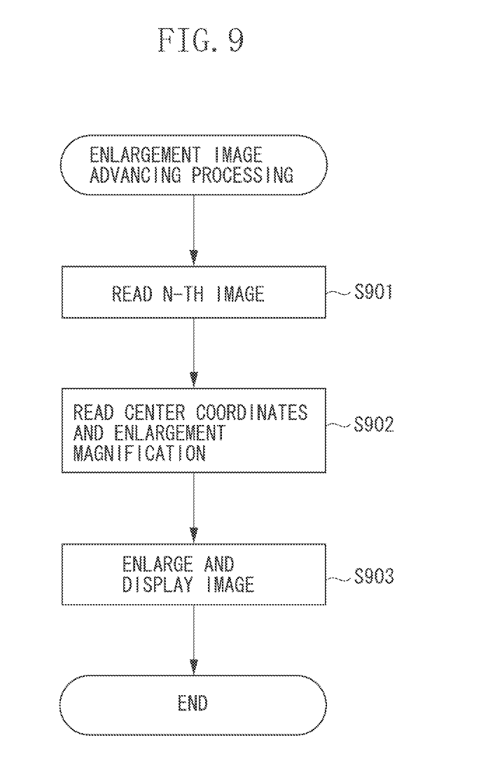

The enlarged image advancing performed in step S721 will be described in detail below with reference to the flowchart illustrated in FIG. 9. The processing is realized by the system control unit 50 loading the program recorded in the non-volatile memory 56 in the system memory 52 and executing it.

If the enlarged image advancing is instructed, in step S901, the system control unit 50 reads the Nth image among the images recorded in the recording medium 200 to the memory 32. In step S902, the system control unit 50 reads the enlargement center coordinates and the magnification stored in the memory 32. In step S903, the system control unit 50 enlarges and displays the image using the read center coordinates and magnification.

According to the present exemplary embodiment, if the touch-move operation of one point is performed in the state where there is no hover detection in the processing of step S802 to step S807 of the flowchart illustrated in FIG. 8, the system control unit 50 moves the enlargement position in step S805. If the system control unit 50 then detects the touch-down operation of the second point, the processing proceeds to step S704. The system control unit 50 then becomes ready to receive the enlarged image advancing instruction by the user touch-moving the two touched-down points in the same direction.

In such a case, if the user subsequently instructs enlarged image advancing, the enlargement position may have been moved in step S805 regardless of the user's intention. The enlargement position may thus be displaced between the images before and after performing enlarged image advancing. To solve such a problem, the system control unit 50 may determine, before moving the enlargement position in step S805, whether the touch-move operation is performed for a predetermined distance or longer or for a predetermined period or longer. In such a case, it can be determined that the operator is explicitly moving the enlargement position, so that the enlarged image advancing can be performed without unintentionally moving the enlargement position.

The present invention has been described in detail based on the exemplary embodiments. However, it is not limited thereto, and various exemplary embodiments within the scope of the invention are included therein. Further, each of the above-described exemplary embodiments is just an exemplary embodiment of the present invention, and each of the exemplary embodiments can be combined as appropriate.

Furthermore, according to the above-described exemplary embodiment, the present disclosure is applied to the digital camera. However, it is not limited thereto, and the present disclosure is applicable to any display control apparatus capable of realizing the enlarged image advancing by performing the touch-move operation of two points at the same time.

For example, the image advancing can be intuitively performed by the touch operation without moving the enlargement position while performing the enlargement reproduction in a smartphone or a tablet personal computer (PC). As a result, the present disclosure is applicable to a PC, a personal digital assistant (PDA), a mobile phone, a portable image viewer, a printer apparatus including a display, a digital photo frame, a music player, a game console, and an electronic book reader.

According to the present disclosure, the image can be smoothly switched to another image while being enlarged without changing the enlargement position.

### OTHER EMBODIMENTS

Embodiments of the present invention can also be realized by a computer of a system or apparatus that reads out and executes computer executable instructions recorded on a storage medium (e.g., a non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of priority from Japanese Patent Application No. 2013-211303 filed Oct. 8, 2013, which is hereby incorporated by reference herein in its entirety.

What is claimed is:

1. A display control apparatus comprising:
a touch detection unit configured to detect a touch operation on a display unit;
an enlargement display unit configured to enlarge and display a range of a portion of an image displayed on a display area of the display unit;
an enlargement position instruction unit configured to instruct, in a case where an image is enlarged and displayed on the display unit, changing an enlargement position of the image, which has been enlarged and displayed, based on movement of a touch position of one point in a state where the touch detection unit has detected that the one point has been touched; and
a control unit configured to control, in a case where a first image is enlarged and displayed on the display unit, switching a display on the display unit from enlargement display of the first image to enlargement display of a second image based on a position instructed by the enlargement position instruction unit with respect to the first image, according to touch positions of at least two points moving in a same direction in a state where the touch detection unit has detected that the at least two points are being touched.

2. The display control apparatus according to claim 1, further comprising a magnification instruction unit configured to instruct changing magnification of the enlarged and displayed image,
wherein the control unit controls, in a case where the second image is to be enlarged and displayed, to perform enlargement display of the second image based on an enlargement position instructed by the enlargement position instruction unit and magnification instructed by the magnification instruction unit with respect to the first image.

3. The display control apparatus according to claim 2, further comprising a storing unit configured to store information on an enlargement position instructed by the enlargement position instruction unit,
wherein the control unit performs control, in a case where the second image is to be enlarged and displayed, to perform enlargement display of an enlargement position based on the information on the enlargement position stored in the storing unit.

4. The display control apparatus according to claim 3, wherein the storing unit further stores information on display magnification instructed by the magnification instruction unit, and
wherein the control unit performs control, in a case where the second image is to be enlarged and displayed, to perform enlargement display at magnification based on the information on the magnification stored in the storing unit.

5. The display control apparatus according to claim 1,
wherein the enlargement position instruction unit instructs, in a case where the touch position of the point is moved at least a predetermined distance, changing an enlargement position of the enlarged and displayed image.

6. The display control apparatus according to claim 1,
wherein the enlargement position instruction unit instructs, in a case where the touch position of the point is moved for at least a predetermined period, changing an enlargement position of the enlarged and displayed image.

7. The display control apparatus according to claim 1, further comprising a guide display unit configured to control, in a case where two points are touched on the display unit and moved in a same direction in a state where the enlargement display unit is performing enlargement display of an image, displaying a guide on a touch operation method for performing enlargement display of another image based on an enlargement position instructed on an image before switching.

8. The display control apparatus according to claim 1,
wherein a guide on a touch operation method for performing enlargement display of another image based on an enlargement position instructed on an image before switching in response to at least a predetermined period elapsing while one point has been touched on the display unit in a state where the enlargement display unit is performing enlargement display of an image is displayed.

9. The display control apparatus according to claim 1,
wherein the control unit performs control, in a case where at least a predetermined period has elapsed while the one point has been touched on the display unit and the point is then moved in a predetermined direction in a state where the enlargement display unit is performing enlargement display of an image, to perform enlargement display of the second image based on an enlargement position instructed with respect to the first image when enlargement display of the second image the second image is to be performed.

10. The display control apparatus according to claim 1, further comprising a hover detection unit configured to detect a hover state in which a finger is placed close to the display unit without touching,
wherein the control unit does not change, in a case where the hover detection unit has detected a hover state when the touch detection unit has detected that the one point has been touched, an enlargement position instructed by the enlargement position instruction unit.

11. The display control apparatus according to claim 1,
wherein the control unit performs control, in a case where enlargement display of the first image is performed on the display unit, to change magnification of the first image according to touch positions of two points moving in directions away from each other or closer to each other in a state where the touch detection unit has detected that the at least two points are being touched.

12. The display control apparatus according to claim 11,
wherein the control unit performs control to switch displaying on the display unit from enlargement display of the first image to enlargement display of the second image based on a position instructed by the enlargement position instruction unit with respect to the first image, in response to touching of two points among the at least two points detected to be touched by the touch detection unit being released after touch positions of the two points moving in the same direction from the state where the at least two points have been detected to be touched by the touch detection unit without changing magnification of the first image based on movement of the touch positions of the two points in directions away from each other or closer to each other.

13. The display control apparatus according to claim 1,
wherein the control unit performs control to switch displaying on the display unit from an enlargement display of the first image to an enlargement display of the second image based on a position instructed by the enlargement position instruction unit with respect to the first image, in response to touching of two points among the at least two points detected to be touched by the touch detection unit becoming released after touch positions of the two points have moved in a same direction from the state where the at least two points have been detected to be touched by the touch detection unit.

14. A control method for a display control apparatus comprising:
detecting a touch operation on a display unit;
enlarging and displaying a range of a portion of an image displayed on a display area of the display unit;
instructing, in a case where an image is enlarged and displayed on the display unit, changing an enlargement position of the image which has been enlarged and displayed, based on movement of a touch position of one point in a state where it has been detected that the one point has been touched; and
controlling, in a case where a first image is enlarged and displayed on the display unit, switching a display on the display unit from enlargement display of the first image to enlargement display of a second image based on the instructed position with respect to the first image, in response to touch positions of two points moving in a same direction in a state where it has been detected that the at least two points are being touched.

15. A non-transitory computer-readable storage medium storing a program for causing a computer to function as each unit in a display control apparatus comprising:
a touch detection unit configured to detect a touch operation on a display unit;
an enlargement display unit configured to enlarge and display a range of a portion of an image displayed on a display area of the display unit;
an enlargement position instruction unit configured to instruct, in a case where an image is enlarged and displayed on the display unit, changing an enlargement position of the image, which has been enlarged and displayed, based on movement of a touch position of one point in a state where the touch detection unit has detected that the one point has been touched; and
a control unit configured to control, in a case where a first image is enlarged and displayed on the display unit, switching a display on the display unit from enlargement display of the first image to enlargement display of a second image based on a position instructed by the enlargement position instruction unit with respect to the first image, according to touch positions of at least two points moving in a same direction in a state where the touch detection unit has detected that the at least two points are being touched.

16. A display control apparatus comprising:
a touch detection unit configured to detect a touch operation on a display unit;
an enlargement display unit configured to enlarge and display a range of a portion of an image displayed on a display area of the display unit;
an enlargement position instruction unit configured to instruct, in a case where a first image is enlarged and displayed on the display unit, changing an enlargement position of the first image which has been enlarged and displayed, based on movement of a touch position of one point in a state where the touch detection unit has detected that the one point has been touched; and
a control unit configured to control, in a case where the first image is enlarged and displayed on the display unit, switching a display on the display unit from enlargement display of the first image to enlargement display of a second image based on a position instructed by the enlargement position instruction unit with respect to the first image, according to touch positions of at least two points moving in a same direction in a state where the touch detection unit has detected that the at least two points are being touched.

17. A control method for a display control apparatus comprising:
detecting a touch operation on a display unit;
enlarging and displaying a range of a portion of a first image displayed on a display area of the display unit;
instructing changing an enlargement position of the image which has been enlarged and displayed; and
controlling, in a case where the first image is enlarged and displayed on the display unit, switching a display on the display unit from enlargement display of the first image to enlargement display of a second image based on the instructed position with respect to the first image, in response to touch positions of at least two points moving in a same direction in a state where it has been detected that the at least two points are being touched.

18. A non-transitory computer-readable storage medium storing a program for causing a computer to function as each unit in a display control apparatus comprising:
a touch detection unit configured to detect a touch operation on a display unit;
an enlargement display unit configured to enlarge and display a range of a portion of an image displayed on a display area of the display unit;
an enlargement position instruction unit configured to instruct, in a case where a first image is enlarged and displayed on the display unit, changing an enlargement position of the first image which has been enlarged and displayed, based on movement of a touch position of one point in a state where the touch detection unit has detected that the one point has been touched; and
a control unit configured to control, in a case where the first image is enlarged and displayed on the display unit, switching a display on the display unit from enlargement display of the first image to enlargement display of a second image based on a position instructed by the enlargement position instruction unit with respect to the first image, according to touch positions of at least two points moving in a same direction in a state where the touch detection unit has detected that the at least two points are being touched.
